(19) United States
(12) Patent Application Publication
(10) Pub. No.: US 2016/0363774 A1
(43) Pub. Date: Dec. 15, 2016

(54) DISPLAY CONTROL METHOD, COMPUTER-READABLE RECORDING MEDIUM, INFORMATION PROCESSING TERMINAL, AND WEARABLE DEVICE

(71) Applicant: FUJITSU LIMITED, Kawasaki-shi (JP)

(72) Inventor: Kazuhisa Kawasima, Shizuoka (JP)

(21) Appl. No.: 15/168,953

(22) Filed: May 31, 2016

(30) Foreign Application Priority Data
Jun. 12, 2015 (JP) 2015-119212

(51) Int. Cl. G02B 27/01; G06T 11/60

(52) U.S. Cl. CPC G02B 27/0179; G06T 11/60; G02B 27/017; G02B 2027/0138

(57) ABSTRACT

A display control method is disclosed. An image is received from a specific terminal. A computer displays the received image at a position of a display area of a display device. The position corresponds to an image of the specific terminal in an image captured by an imaging device, when detecting at least one of the image of the specific terminal and an image corresponding to the specific terminal in the received image.

### CROSS-REFERENCE TO RELATED APPLICATIONS

This application is based upon and claims the benefit of priority of the prior Japanese Patent Application No. 2015-119212, filed on Jun. 12, 2015, the entire contents of which are incorporated herein by reference.

### FIELD

The embodiments discussed herein are related to a display control method, a computer-readable recording medium, an information processing terminal, and a wearable device.

### BACKGROUND

Recently, since portable terminals have been widely used, the number of users increases, which users refer to various information items stored in their mobile phones or use electronic mail (hereinafter, simply called e-mail) at public areas such as inside trains, and the like.

In order to prevent private information from being looked at by others and present the private information to the users, it has been considered to display a screen, which is to be displayed at the mobile terminal, at a head mounted display (hereinafter, called HMD).

A technology is provided to precisely specify a display location of a screen of the mobile terminal when information is displayed at the HMD. A technology is provided to display a blank region for high security information included in an electronic document at a fixed display, and to display the high security information at a display section of the HMD so as to overlap with the blank region. Other technology is provided to display information input by handwriting with stylus pen or the like if the information is private, instead of displaying the information on the HMD.

### Patent Documents

Japanese Laid-open Patent Publication No. 2014-011655

Japanese Laid-open Patent Publication No. 2006-277239

Japanese Laid-open Patent Publication No. 2015-001657

### SUMMARY

According to one aspect of the embodiments, there is provided A display control method, including: receiving an image from a specific terminal; and displaying, by a computer, the received image at a position of a display area of a display device, the position being corresponded to

an image of the specific terminal in an image captured by an imaging device, when detecting at least one of the image of the specific terminal and an image corresponding to the specific terminal in the received image.

The object and advantages of the invention will be realised and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a system in a first embodiment;

FIG. 2 is a diagram illustrating a hardware configuration of a mobile terminal;

FIG. 3 is a diagram illustrating a hardware configuration of a HMD;

FIG. 4 is a diagram illustrating a functional configuration of the mobile terminal;

FIG. 5 is a diagram illustrating a functional configuration example of the HMD;

FIG. 6 is a flowchart for explaining a display control process in the mobile terminal;

FIG. 7 is a flowchart for explaining an entire process of the HMD;

FIG. 8A and FIG. 8B are diagrams illustrating display examples of a second display screen;

FIG. 9 is a diagram illustrating an example of displaying markers at four corners of a screen of the mobile terminal;

FIG. 10 is a diagram illustrating an application example in a case of using the system according to the first embodiment in a public place;

FIG. 11 is a diagram illustrating a display example in which contents are not displayed at the mobile terminal;

FIG. 12 is a diagram illustrating a display example in which a marker is displayed at the mobile terminal;

FIG. 13 is a diagram illustrating a display example in which contents related to private information are not displayed at the mobile terminal; and

FIG. 14 is a diagram for explaining a system in a second embodiment.

### DESCRIPTION OF EMBODIMENTS

In the above described technologies, display control for the private information is controlled. However, the above described technologies do not sufficiently consider operability for a user who enters information to the mobile terminal.

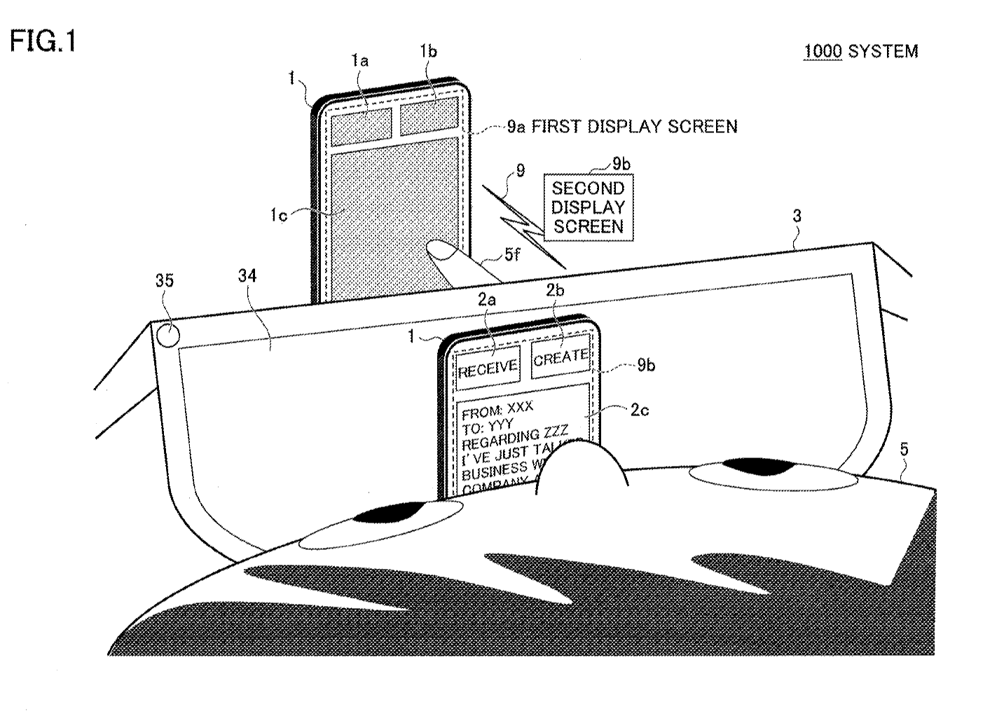

Preferred embodiments of the present invention will be described with reference to the accompanying drawings. FIG. 1 is a diagram for explaining a system in a first embodiment. A system 1000 in the first embodiment depicted in FIG. 1 includes a mobile terminal I and a head mounted display (HMD) 3, which are mutually connected via short-range wireless communication 9. In FIG. 1, the HMD 3 is mounted on a head, and a view is depicted from above the head of a user 5 conducting an input operation to the mobile terminal 1 toward a front of the user 5 in an obliquely downward direction.

The mobile terminal 1 may be any kind of a portable information processing terminal such as a cellular phone, a tablet terminal, or the like. The mobile terminal 1 conducts a display control of suppressing displaying information to minimum to prevent private information and input information from being read from input operations of a finger 5f of the user 5, and of displaying the private information and the input operation at the HMD 3.

A first display screen 9a displayed at the mobile terminal 1 corresponds to a screen for a minimum display pertinent to operability. The first display screen 9a does not display any letters but displays only each area of display components 1a, 1b, and 1c to be visible.

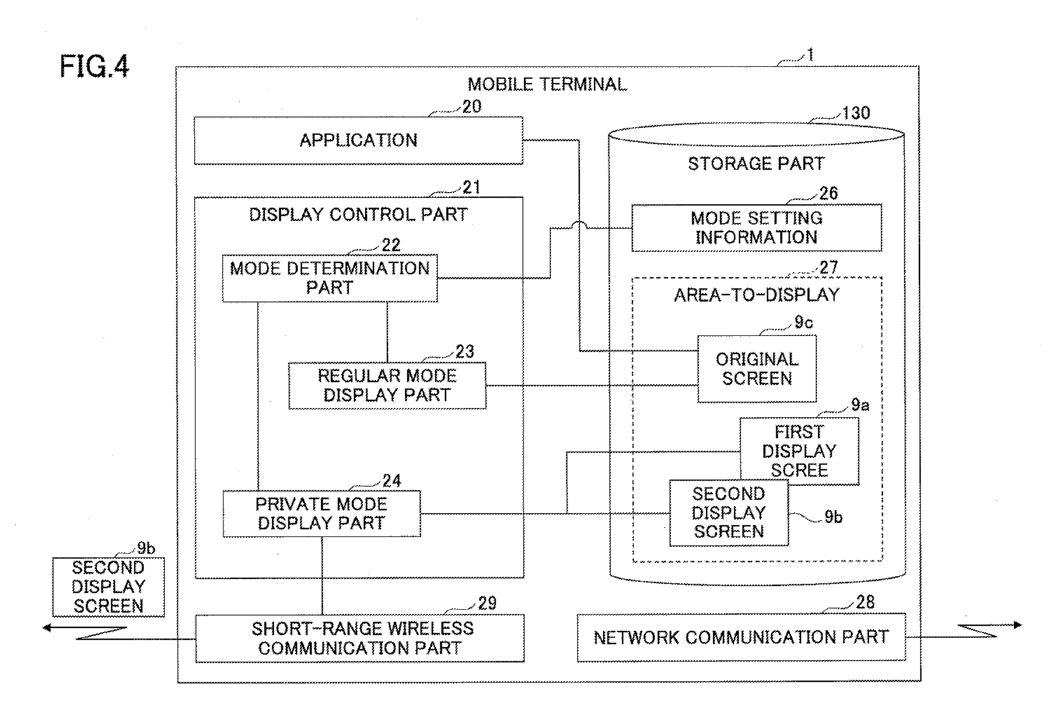

In FIG. 1, as one example, each area of the display components 1a, 1b, and 1c is filled with the same color. Widgets provided by an application 20 (FIG. 4) correspond to the display components 1a, 1b, and 1c.

The HMD 3 is an example of a wearable device to foe mounted on the head and having a shape of a pair of glasses. The HMD 3 includes a display part 34 being a transmission type, and a camera 35. It is possible for the user 5 to see ahead through the HMD 3.

When receiving a second display screen 9b from the mobile terminal 1 by the short-range wireless communication S, the HMD 3 displays the received second display screen 9b at the display part 34 by placing it at a position of the mobile terminal I, which the user 5 sees through the display part 34. The user 5 sees a state in which the second display screen 9b displayed at the display part 34 of the HMD 3 is overlapped with the mobile terminal 1 actually seen through the HMD 3.

The second display screen 9b corresponds to a display screen, which the mobile terminal 1 regularly displays. In this example, the second display screen 9b includes a display component 2a including letters “RECEIVE”, a display component 2b including letters “CREATE”, and a display component 2c including letters or sentences

“from: XXX

to: YYY

Regarding ZSZ

I've just talked business with company A. . . . ”. As described below, the display component 2a and the display component 2b may be omitted.

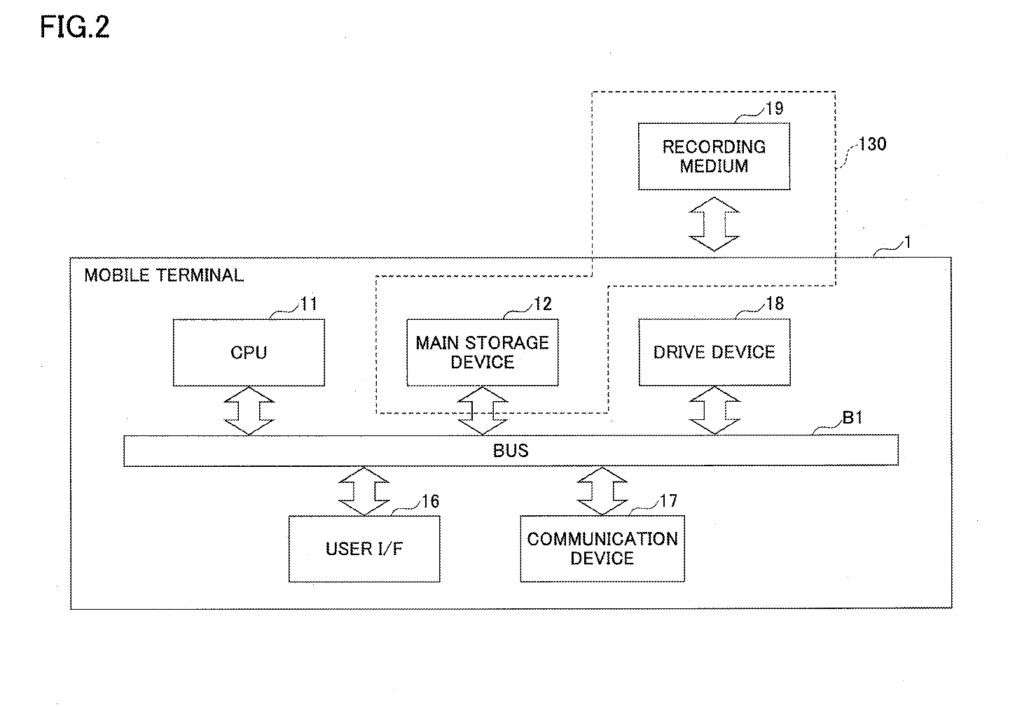

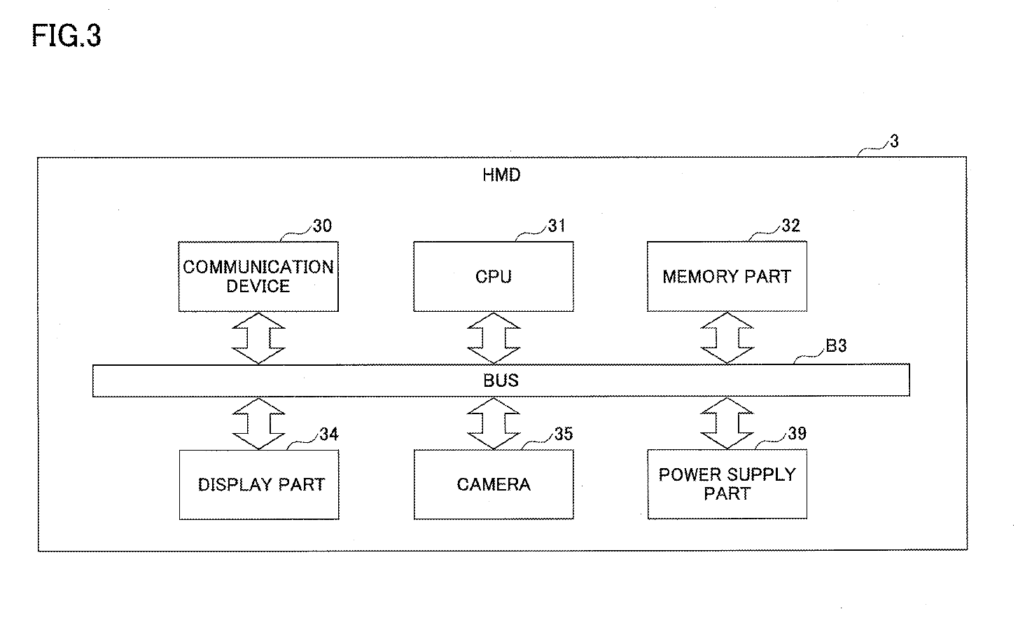

Hardware configurations of the mobile terminal 1 and the HMD 3 in the system 1000 will foe described with reference to FIG. 2 and FIG. 3.

FIG. 2 is a diagram illustrating a hardware configuration of the mobile terminal. In FIG. 2, the mobile terminal 1 corresponds to the portable information processing terminal such as the tablet type, the mobile phone, or the like, which is controlled by a computer. The mobile terminal 1 includes a Central Processing Unit (CPU) 11, a main storage device 12, a user InterFace (I/F) 16, a communication device 17, and a drive device 18, which are mutually connected via a bus B1.

The CPU 11 controls the mobile terminal 1 as a processor in accordance with a program stored in the main storage device 12. For the main storage device 12, a Video Random Access Memory (VRAM), and Read Only Memory (ROM), or the like are used to store or temporarily retain the program to be executed by the CPU 11, data used in a process by the CPU 11, data acquired in the process by the CPU 11, and the like. The program stored in the main storage device 12 is executed by the CPU 11, and various processes are realized.

The user I/F 16 displays various information items under control of the CPU 11. The user I/F 16 may be a touch panel or the like, which allows the user 5 to operate or input thereon. The communication device 17 controls various communications such as the short-range wireless communication 9 by wireless communications, infrared communications, Wi-Fi (registered trademark), Bluetooth (registered trademark), and the like for sending and receiving radio signals via an antenna or the like, and network communications by the Internet connections and the like. The communication control of the communication device 17 is not limited to wireless or wired communication.

The program realizing the process conducted by the mobile terminal 1 may be downloaded from an external device through a network. Alternatively, the program may be stored beforehand in the main storage device 12 of the mobile terminal 1.

The drive device 18 interfaces between a recording medium 19 (such as a micro Secure Digital (SD) memory card or the like) set into the drive device 18 and the mobile terminal 1. The main storage device 12 and/or the recording medium 19 may correspond to a storage part 130.

The mobile terminal 1 may be the information processing terminal such as a desktop type, a notebook type, a laptop type, or the like. The hardware configuration thereof will be the same as the hardware configuration depicted in FIG. 2, and the explanation thereof will be omitted.

FIG. 3 is a diagram illustrating a hardware configuration of the HMD. In FIG. 3, the HMD 3 may correspond to a wearable type of an information processing terminal, which is controlled by a computer and is detachably mounted on a part of the body of the user 5. The HMD 3 includes a communication device 30, a CPU 31, a memory part 32, a display part 34, the camera 35, and a power supply part 39, which are mutually connected via a bus B3.

The communication device 30 conducts the short-range wireless communication 9 by Bluetooth (registered trademark) or the like via an antenna.

The CPU 31 controls the HMD 3 as a processor in accordance with the program stored in the memory part 32. For the memory part 32, a VRAM and a ROM, or the like is used to store or temporarily retain the program to foe executed by the CPU 31, data used in a process by the CPU 31, data acquired in the process by the CPU 31, and the like. The program stored in the memory part 32 is executed by the CPU 31, and various processes are realized.

The display part 34 is a transmissive display, and displays the second display screen 9b under control of the CPU 31. By displaying the second display screen 9b at the display part 34, the user 5 sees the mobile terminal 1 in a real space through the display part 34, with which the second display screen 9b is overlapped. The display part 34 may be a retina display.

The camera 35 captures a scene in a visual line of the user 5. An image captured by the camera 35 is displayed at the display part 34. The power supply part 39 corresponds to, but is not limited to, an internal power supply such as a battery or the like.

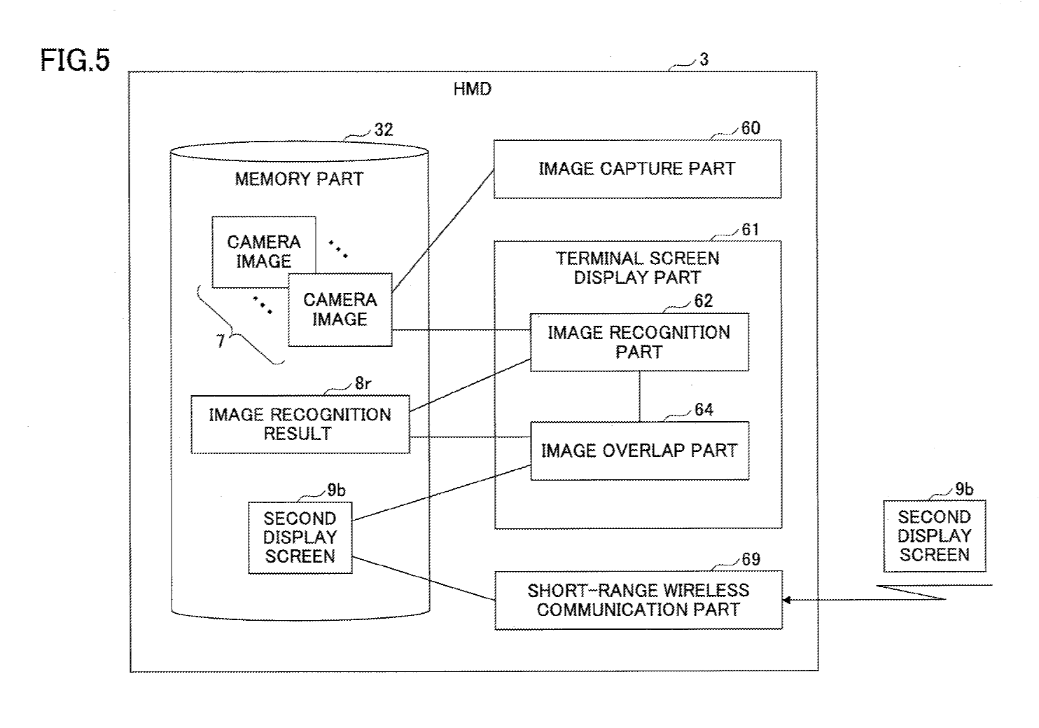

Next, functional configurations of the mobile terminal 1 and the HMD 3 will be described with reference to FIG. 4 and FIG. 5. FIG. 4 is a diagram illustrating a functional configuration of the mobile terminal. In FIG. 4, the mobile terminal 1 mainly includes the application 20, a display control part 21, a network communication part 28, and a short-range wireless communication part 29. The application 20, the display control part 21, the network communication part 28, and the short-range wireless communication part 29 are realized by processes, which respective programs cause the CPU 31 to perform.

Also, the storage part 130 stores mode setting information 26, the first display screen 9a, the second display screen 9b, an original screen 9c, and the like. An area-to-display 27 corresponds to the VRAM of the storage part 130, which stores images pertinent to various displays such as the first display screen 9a, the second display screen 9b, the original screen 9c, and the like.

The application 20 conducts specific processes including processes pertinent to inputs and screens for private information, secret information, and the like. An electronic mail application will be exemplified as the application 20. However, the application 20 is not limited to the electronic mail application.

The display control part 21 includes a mode determination part 22, a regular mode display part 23, and a private mode display part 24.

The mode, determination part 22 is regarded as a process part to refer to the mode setting information 26 retained in the storage part 130 and to switch a display control. When the mode determination part 22 determines that a display mode is a regular mode display, the display control is conducted by the regular mode display part 23. When the mode determination part 22 determines that the display mode is the private mode display, the display control is conducted by the private mode display part 24.

The mode setting information 26 indicates a condition to conduct the private mode display. As a conditional example, the mode setting information 26 may indicate that the private mode is indicated by the user 5, that the application 20 is specified to switch to the private mode.

The regular mode display part 23 is regarded as a process part, which conducts existing display control when the mode determination part 22 determines the regular mode displays. The regular mode display part 23 creates the original screen 9c based on display components 1a to 1c provided from the application 20 and their contents, and displays the original screen 9c at the user I/F 16. The first display screen 9a and the second display screen 9b according to the first embodiment are not generated.

The private mode display part 24 is regarded as a process part to conduct the display control according to the first embodiment when the mode determination part 22 determines that the display mode is the private mode display. The private mode display part 24 generates the first display screen 9a and the second display screen 9b based on the display components 1a to 1c and their contents provided from the application 20, displays the first display screen 9a at the user I/F 16 of the mobile terminal 1, and displays the second display screen 9b at the display part 34 of the HMD 3.

The first display screen Sa corresponds to an image in which buttons, and the display components 1a to 1c such as input areas and the like are visible in consideration of operability for the user 5. In the first display screen 9a, the display components 1a to 1c and the like are displayed by a single color. Respective contents of text, images, a color arrangement of the display components 1a to 1c and the like are omitted and are replaced with a predetermined color.

The second display screen 9b is regarded as an image in which the display components 1a to 1c and their contents provided from the application 20 are depicted in an original state. The image depicted in the original state corresponds to an image in which the text, the image, and the color arrangement are indicated by the application 20.

The network communication part 28 is a process part, which conducts a network communication control by controlling the communication I/F 17 for an Internet connection.

The short-range wireless communication part 29 is regarded as a process part, which conducts control of the short-range wireless communication 9 such as Bluetooth (registered trademark) by controlling the communication device 17. In the first embodiment, the communication control with the HMD 3 is conducted by the short-range wireless communication part 29.

FIG. 5 is a diagram illustrating a

functional configuration example of the HMD. In FIG. 5, the HMD 3 mainly includes an image capture part 60, a terminal screen display part 61, and a short-range wireless communication part 69. Also, the VRAM of the memory part 32 stores camera images 7, the second display screen 9b, and the like.

The image capture part 60 takes in images (the camera images 7) captured by the camera 35 and stores the images into the memory part 32.

The terminal screen display part 61 is regarded as a process part, which displays the second display screen 9b at a position in a display area of the mobile terminal 1 viewed through the display part 34 by converging coordinates of the second display screen 9b. A coordinate conversion is performed with respect to a shape of the second display screen 9b so as to fit a case of projecting the mobile terminal 1 to the display part 34. Then, the second display screen 9b is overlapped with the mobile terminal 1 so as to precisely adjust the shape of the second display screen 9b to fit that of the mobile terminal 1.

The terminal screen display part 61 includes an image recognition part 62, and an image overlap part 64. The image recognition part 62 is regarded as a process part, which reads out the camera images 7 from the memory part 32 and conducts an image recognition process for recognizing the mobile terminal 1. The image recognition part 62 detects position coordinates, a size, a tilt, and the like of the mobile terminal 1 in the camera images 7 by recognizing a screen of the mobile terminal 1, and outputs an image recognition result 8r indicating the detected position coordinates, the detected size, the detected tilt, and the like of the mobile terminal 1. The image recognition result 8r is temporarily stored in the memory part 32.

The image overlap part 64 converts the coordinates of the second display screen 9b received from the mobile terminal 1, based on the image recognition result 8r. Then, the image overlap part 64 displays the second display screen 9b at the display part 34 by positioning to the mobile terminal 1. The image overlap part 64 converts the coordinates of the second display screen 9b received from the mobile terminal 1 based on a screen size, the tilt and the like of the mobile terminal 1 indicated by the image recognition result 8r, and displays the second display screen 9b being converted at the display part 34 based on the position coordinates of the mobile terminal 1 indicated by the image recognition result 8r.

The short-range wireless communication part 69 is regarded as a process part, which controls communications with the mobile terminal 1 through the communication device 30 by a communication method such as Bluetooth (registered trademark).

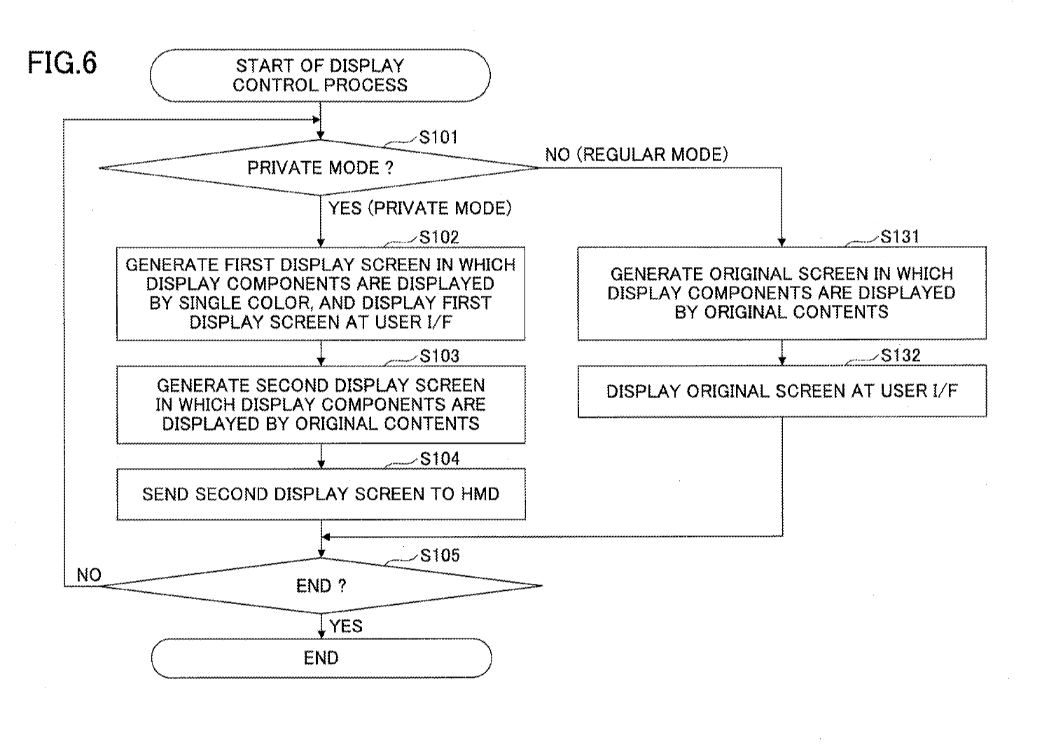

Next, a display control process conducted by the display control part 21 of the mobile terminal I and a terminal screen display process conducted by the image recognition part 62 of the HMD 3 will be described with reference to FIG. 6 to FIG. 8. FIG. 6 is a flowchart for explaining the display control process conducted by the mobile terminal. In FIG. 6, in the mobile terminal 1, the mode determination part 22 of the display control part 21 determines, by referring to the mode setting information 26, whether the display mode is the private mode (step S101).

When the mode determination part 22 determines that the display mode is the private mode (YES of step S101), the private mode display part 24 conducts a private mode display process.

The private, mode display part 24 generates the first display screen 9a by filling the display components 1a to 1c and the like provided from the application 20 with the single color, and displays the first display screen 9a at the user I/F 16 (step S102). The first display screen 9a is stored in the storage part 130.

Also, the private mode display part 24 generates the second display screen 9b in which the display components 1a to 1c and the like are depicted by the original contents provided from the application 20 (step S103). The second display screen 9b is stored in the storage part 130. The second display screen 9b corresponds to an screen in which the display components 1a to 1c are created by applying colors, the text, the images, and the like as the application 20 indicates.

The private mode display part 24 sends the second display screen 9b to the HMD 3 (step S104). Next, the display control part 21 determines whether the display control ends (step S105). When the application 20 ends, that is, the display control ends due to power off of the mobile terminal 1, the display control part 21 ends this display control process.

On the other hand, when the mode determination part 22 determines that the display mode is the regular mode (NO of step S101), the regular mode display part 23 conducts the regular mode process.

The regular mode display part 23 generates the original screen 9c for displaying the original contents of the display contents 1a to 1c as provided from the application 20 (step S131). The original screen 9c is stored in the storage part 130.

Then, the regular mode display part 23 displays the original screen 9c at the user I/F 16 (step S132). After displaying the original screen 9c, the display control part 21 determines whether the display control ends (step S105). When the application 20 ends, that is, when the display control ends since the mobile terminal 1 is turned OFF or the like, the display control part 21 ends the display control process.

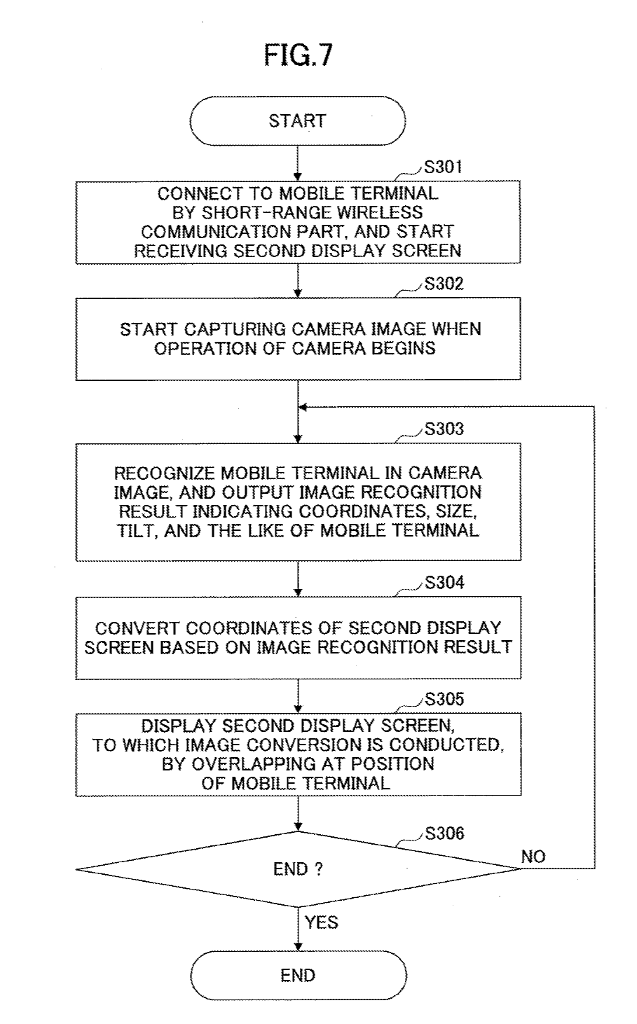

Next, an entire process of the HMD 3 will be described. FIG. 7 is a flowchart for explaining the entire process of the HMD. In FIG. 7, first, the short-range wireless communication part 69 connects to the mobile terminal 1 by the short-range wireless communication 9, and begins receiving the second display screen 9b (step S301).

When the short-range wireless communication 9 is established to the mobile terminal 1, the part image capture part 60 starts an operation of the camera 35, and begins taking in the camera images 7 (step S302). The camera images 7 are accumulated in the memory part 32.

In the terminal screen display part 61, the image recognition part 62 reads the camera images 7 one by one from the memory part 32, and recognizes the mobile terminal 1 by conducting the image recognition process (step S303).

As a method for recognizing the mobile terminal 1, a marker may be displayed at each of corners of the screen of the mobile terminal 1 to recognize the screen. Alternatively, the screen itself of the mobile terminal 1 may be recognized. In this case, the image recognition process detects coordinates of four corners the mobile terminal 1, if the mobile terminal 1 is displayed at the display part 34 of the HMD 3.

The image recognition part 62 calculates the size, the tilt, and the like when the mobile terminal 1 is displayed at the display part 34, by using the coordinates of the detected four corners. The image recognition result 8r indicating the coordinates of the detected four corners, the size, the tilt, and the like is output to the memory part 32.

The image overlap part 64 conducts the coordinate conversion with respect to the second display screen 9b based on the image recognition result 8r (step S304). The image overlap part 64 displays the second display screen 9b to which the coordinate conversion is conducted by overlapping the mobile terminal 1 at the position of the mobile terminal 1 viewed through the display part 34 (step S305).

The terminal screen display part 61 determines whether the process of the HMD 3 ends (step S306). When the short-range wireless communication 9 with the mobile terminal 1 is disconnected, it is determined that the process of the HMD 3 ends. When the process of the HMD 3 does not end (NO of step S306), the terminal screen display part 61 returns to step S303, and acquires a next camera image 7. The above described processes will be repeated. On the other hand, when the process of the HMD 3 ends (YES of step S306), the terminal screen display part 61 ends displaying the second display screen 9b at the display part 34 of the HMD 3.

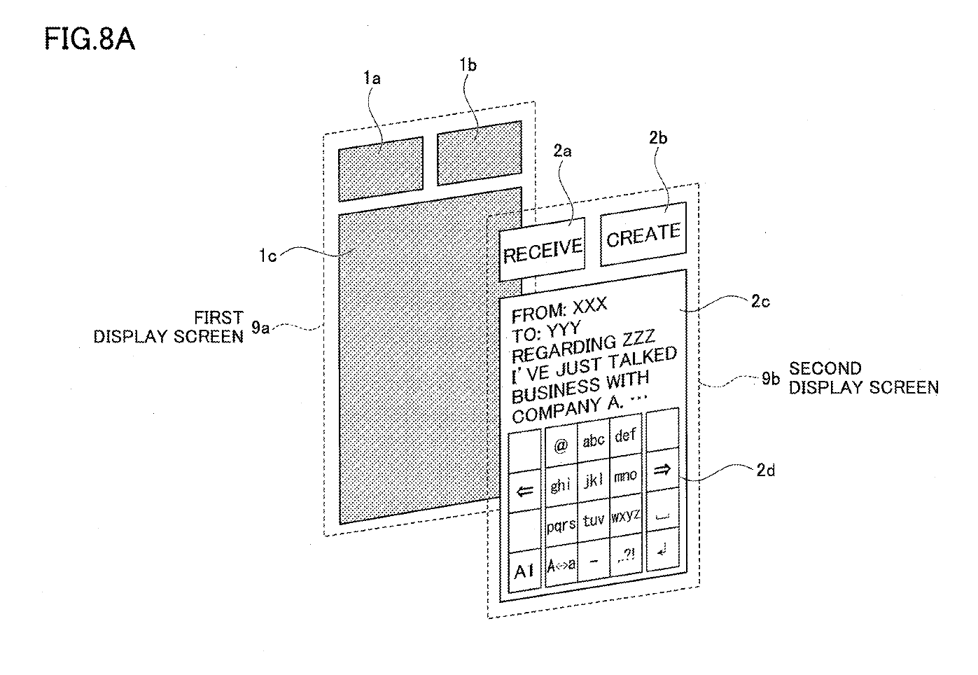

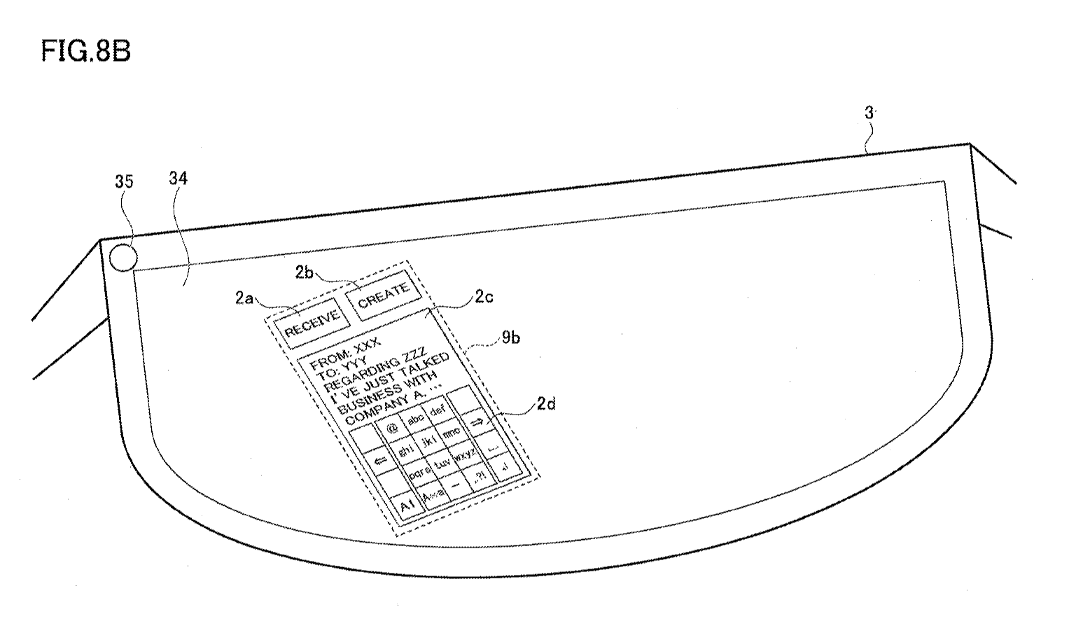

Next, a display example of the display part 34 will be described. In the display example, the second display screen 9b generated by the mobile terminal 1 is displayed at the display part 34 after the coordinate conversion is conducted by the HMD 3. FIG. 8A and FIG. 8B are diagrams illustrating the display examples of the display screens 9a and 9b.

In FIG. 8A, an example of the first display screen 9a and the second display screen 9b, which are generated by the mobile terminal 1 stored in the storage part 130, are depicted. In the first display screen 9a, the display components 1a, 1b, 1c, and the like are filled with the single color in a degree capable of determining their areas.

In FIG. 8B, the second display screen 9b corresponding to the original screen 9c, which is to be displayed at the mobile terminal 1 by the application, is viewed through the HMD 3. By the second display screen 9b, the user 5 sees that the display components 2a to 2c and a display component 2d actually exist.

In FIG. 8A, since all of the display components 1a to 1c and the like are displayed with the single color, it is not distinguished in that the display component 1c further includes a display component. By controlling not to distinguish an area of the display component of a software key set such as the display component 2d, it is possible to ensure secrecy of inputs.

As depicted in FIG. 8B, the second display screen 9b displayed at the HMD 3 is overlapped on the mobile terminal 1 viewed by naked eyes through the HMD 3. The user 5 easily recognizes a state of overlapping the mobile terminal and the second display screen 9b. Hence, the operability of the user 5 to the mobile terminal 1 is improved.

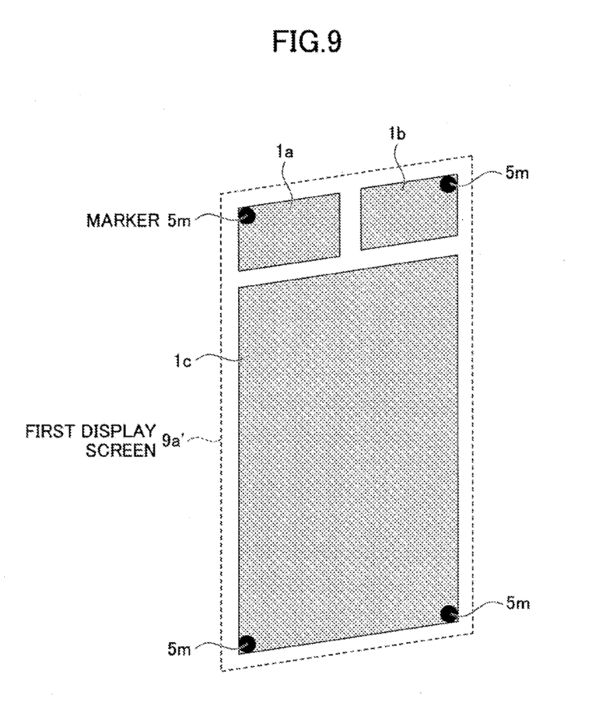

Next, an example of displaying the markers will be described in a case of recognizing the mobile terminal 1 by the markers. FIG. 9 is a diagram illustrating an example of displaying the markers at the four corners of the screen of the mobile terminal. In a first display screen 9a′ illustrated in FIG. 9, markers 5m are additionally displayed at the four corners in the first display screen 9a.

The image recognition part 62 of the HMD 3 precisely acquires the size, the tilt, and the like of the mobile terminal 1 by recognizing the four markers 5m from each of the camera images 7. The markers 5m may be, but are not limited to, Augmented Reality (AR) markers, barcodes, QR codes (registered trademark), or the like, which are recognizable for the HMD 3.

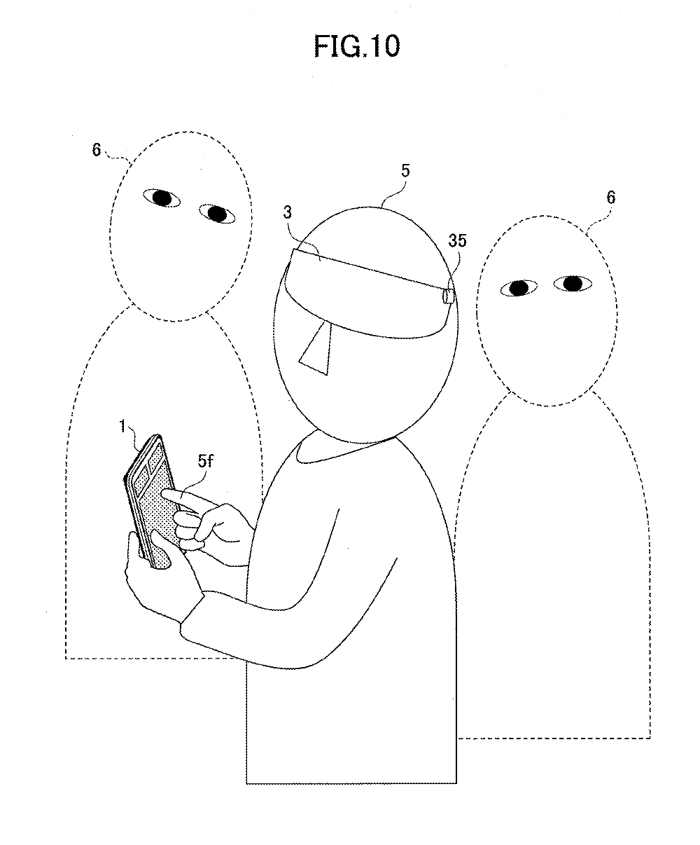

FIG. 10 is a diagram illustrating an application example in a case of using the system according to the first embodiment in a public place. In FIG. 10, it is assumed in that the user 5 is surrounded by other persons 6 in the public place and uses the system 1000 according to the first embodiment.

The second display screen 9b corresponding to the original screen 9c is displayed at the HMD 3 mounted on the head of the user 5, and the first-display screen 9a is displayed at the mobile terminal 1. Even if the other persons 6 attempt to see the display of the mobile terminal 1, it is difficult for the other persons 6 to see contents such as the private information and the like. It is difficult for the other persons 6 to know the contents such as the private information and the like. In addition, the display component 2d such as the software key set or the like is not displayed at the mobile terminal 1. Hence, it is difficult for the other persons 6 to predict input information from operations of the user 5.

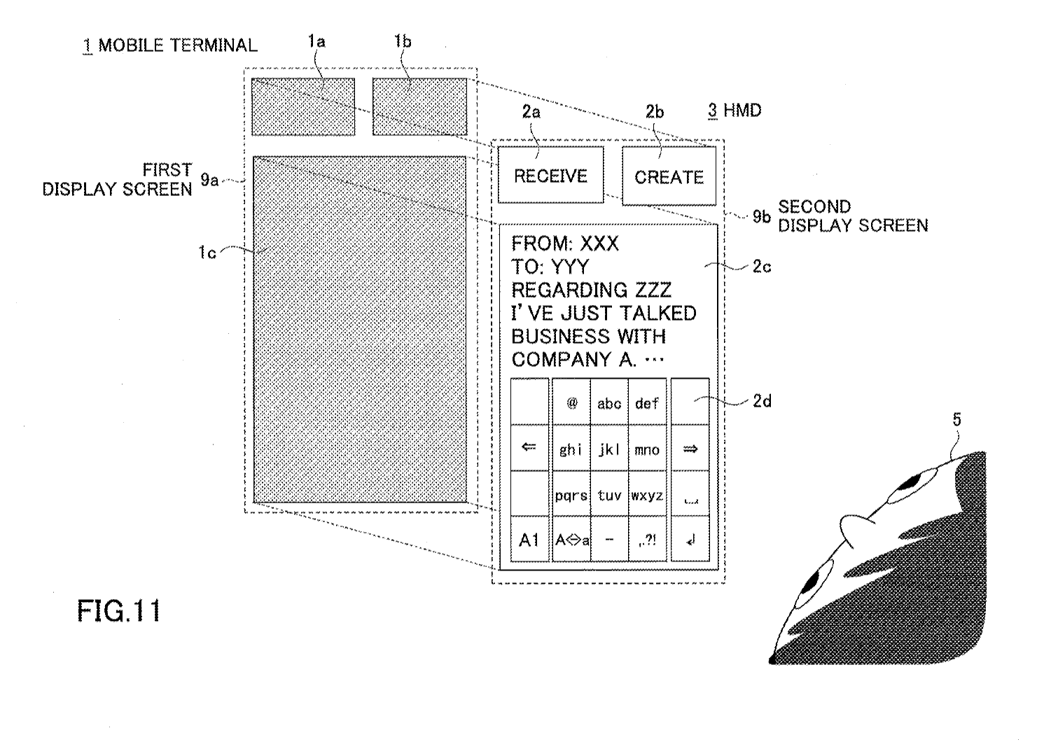

As described above, different from an existing mirror cast technology in which the original screen 9c is displayed by synchronizing the mobile terminal 1 with the HMD 3, the first embodiment realizes a different display between the mobile terminal 1 and the HMD 3. Screen examples displayed at the mobile terminal 1 and the HMD 3 at the same time will be described with reference to FIG. 11 to FIG. 13. In FIG. 11 to FIG. 13, the application 20 is the electronic mail application.

FIG. 11 is a diagram illustrating a display example in which the contents are not displayed at the mobile terminal. At the mobile terminal 1, the first display screen 9a is displayed as described above. The display components 1a to 1c are simply displayed with the single color.

On the other hand, at the HMD 3, the second display screen 9b is displayed and the display components 2a to 2d are displayed with the original contents. The display components 2a to 2c correspond to the display components 1a to 1c. The display components 2c and 1c display contents of an electronic mail (hereinafter, simply called e-mail). By displaying the original contents, letters, and the like arranged to keys are displayed on the display component 2d for the software key set at the HMD 3.

It is difficult to see the arrangement of the software keys from the first display screen 9a of the mobile terminal 1. Moreover, it is difficult to determine whether a current arrangement of the software keys is for alphanumeric or Japanese letters, since the arrangement of the software keys is changed between the alphanumeric and the Japanese letters.

The user 5 viewing the second display screen 9b of the HMD 3 attempts to match a location of a key selected from the software keys displayed at the HMD 3 with a location in the display component 1c of the mobile terminal 1. In the first embodiment, the user 5 easily and visually matches the display component 1c filled with the single color with the display component 2c on which the original contents are displayed. It is possible to easily specify a key location of the mobile terminal l, and to easily operate keys to the mobile terminal 1.

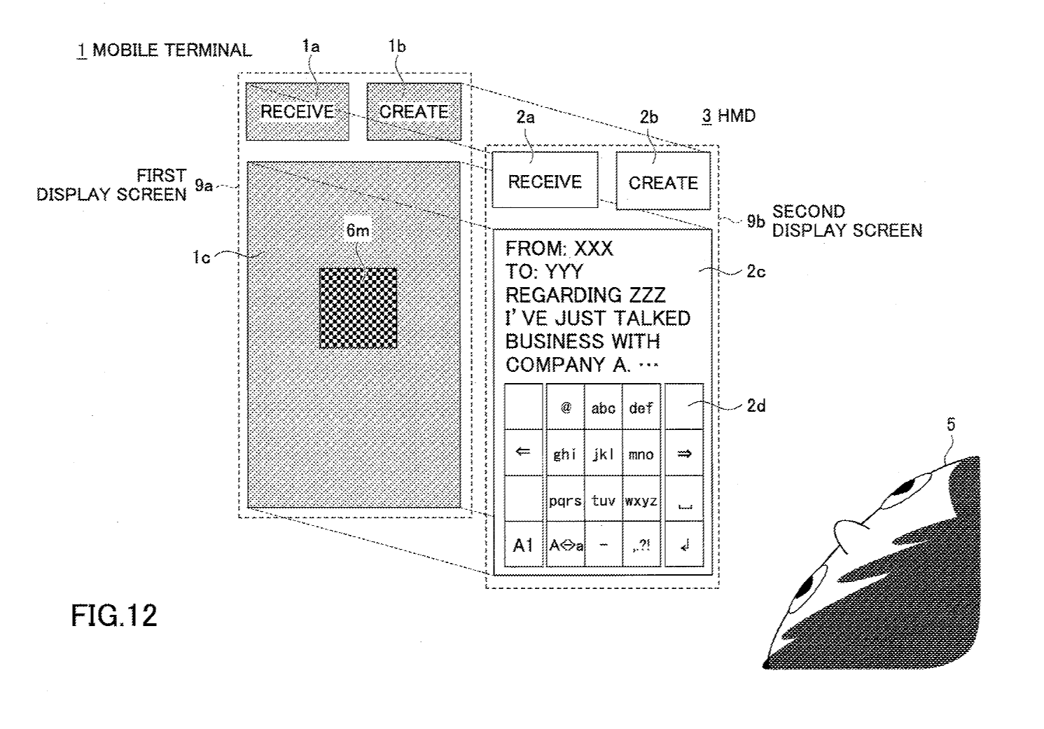

FIG. 12 is a diagram illustrating a display example in which a marker is displayed at the mobile terminal. At the mobile terminal 1, instead of the original contents, a marker 6m is displayed in the display component 1c displaying the private information. In this example, the original contents are the contents of the e-mail, and the marker 6m is displayed, instead of the contents of the e-mail.

The marker 6m includes information of the size of the mobile terminal 1. By detecting the marker 6m in the HMD 3 by the image recognition process, the size of the mobile terminal 1 may be acquired from the marker 6m. On the other hand, the marker 6m may not include information of the size. By using an image pattern of the marker 6m, the tilt of the mobile terminal 1 is easily calculated. In this case, regardless of a type of the mobile terminal 1, the marker 6m may be displayed by a predetermined image pattern. The marker 6m may be, but is not limited to, the AR marker, the barcode, the QR code, or the like.

In the display examples in FIG. 11 and FIG. 12, the display components 1a to 1c are filling with the single color and are displayed. The user 5 easily and visibly recognizes an overlap degree between the first display screen 9a and the second display screen 9b. Hence, the user 5 operates the keys to input each letter without uncertainty due to displacement of the keys to press. Even if a certain amount of an overlap displacement is caused, the user 5 recognises the overlap displacement and operates the keys. Accordingly, the operability for the user 5 is improved.

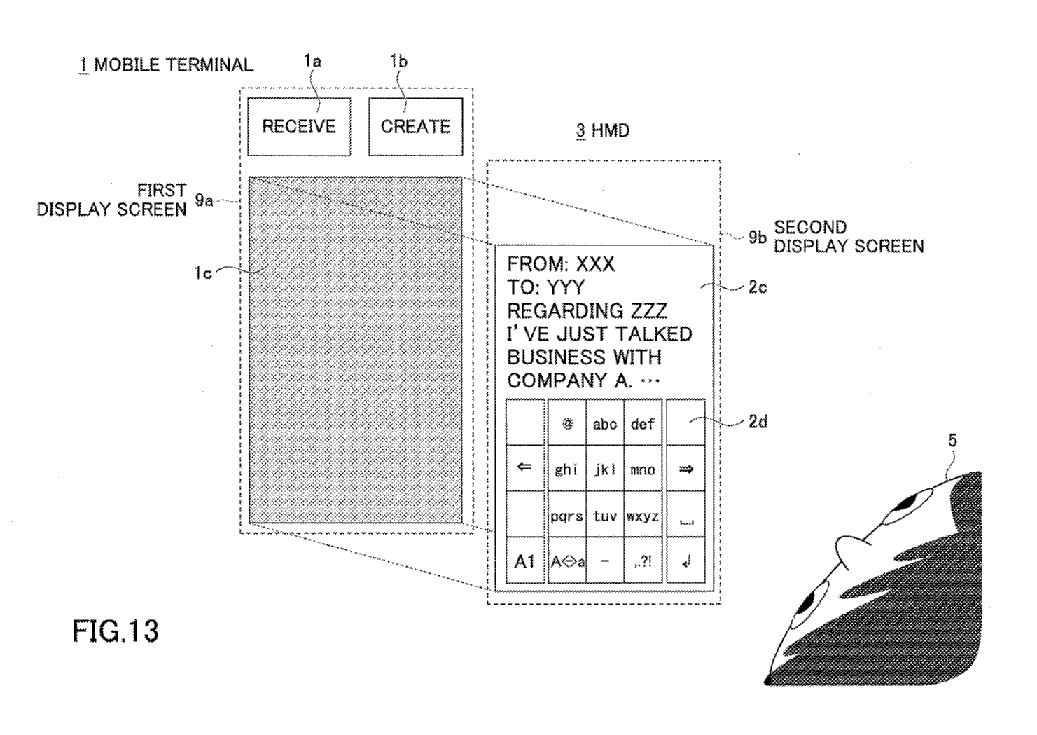

FIG. 13 is a diagram illustrating a display example in which contents related to the private information are not displayed at the mobile terminal. The mobile terminal 1 displays the display component 1c, in which the private information is to be displayed, with the single color. It is possible for the user 5 to see the display components 2c and 2d of the second display screen 9b being overlaid with the display component 1c at the HMD 3. By displaying the display component 1c by the single color, it is possible to easily confirm the overlap of the display components 2c and 2d of the second display screen 9b.

It is possible for the user 5 to confirm the contents of the e-mail without the contents being glanced at by another person, and it is possible to realize an excellent operability of key inputs.

In the example in FIG. 13, the letters, colors, and the like of the original contents are displayed for the display contents la and lb at the mobile terminal 1. In the example of the second display screen 9b, the display components la and lb are omitted.

Similar to the display examples in FIG. 11 and FIG. 12, the user 5 views the contents of the e-mail without their being read by the other persons 6. Also, it is possible for the user 5 to input the keys in a process of creating the contents of the e-mail without their being read by the other persons 6. The user 5 easily recognizes the overlap of the display component 1c displayed at the mobile terminal 1 by the single color with the display component 2c displayed at the HMD 3. By referring

to the display component 2d being displayed, the key input is easily conducted.

In the first embodiment, a case of

operating the mobile terminal 1 is described. An object of the input operation by finger 5f of the user 5 is not limited to the mobile terminal 1. The user 5 may specify a point in the keys displayed at the HMD 3 by the finger 5f in the air.

Also, in a case in which the user 5 operates the keys in the air and does not feel reality of the operations, a thing other than the mobile terminal 1 may be used as a pseudo-object. The pseudo-object may be any existing thing around the user 5. For instance, any substantive material such as a notebook, a box, a book, a cup to drink, or the like may be used as the pseudo-object.

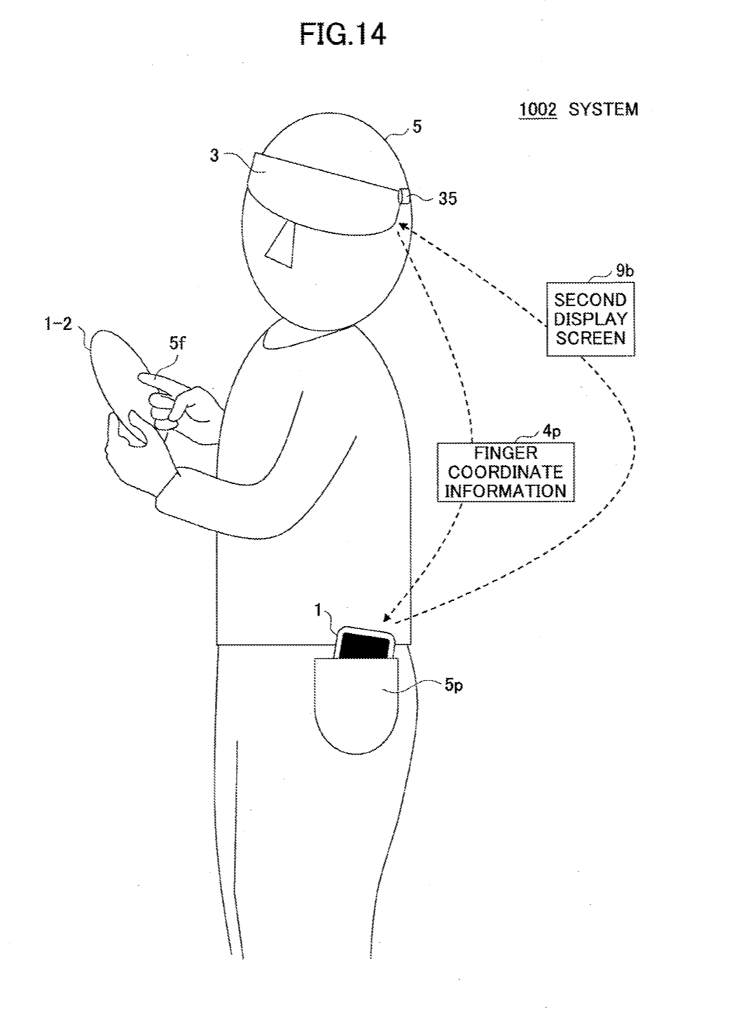

A second embodiment will be described below. In the second embodiment, the user 5 operates the pseudo-object other than the mobile terminal 1. FIG. 14 is a diagram for explaining a system in the second embodiment.

Similar to the first embodiment, a system 1002 illustrated in FIG. 14 includes the mobile terminal 1 and the HMD 3, and the mobile terminal 1 and the HMD 3 are connected by the short-range wireless communication 9. Different from the first embodiment, the mobile terminal 1 is input in a pocket 5p or the like, and the user 5 conducts the operation of the mobile terminal 1 with respect to a pseudo-object 1-2.

Similar to the first embodiment, in a case of the private mode, the mobile terminal 1 sends the second display screen 9b to the HMD 3. In the second embodiment, contents are not displayed at the user I/F 16 of the mobile terminal 1. An entire display area of the user I/F 16 may be displayed by the single color, and a predetermined wall paper may be displayed.

When receiving the second display screen 9b, the HMD 3 displays the second display screen 9bat a predetermined position on the display part 34. The mobile terminal 1 may be input into the pocket 5p or the like, ant the user 5 may operate the mobile terminal 1 in the air by referring to the second display screen 9b displayed at the HMD 3 and using the finger 5f.

In the second embodiment, the HMD 3 recognizes the mobile terminal 1 similar to the first embodiment, but does not conduct an overlap process using the received second display screen 9b. Instead, the finger 5f is recognized,, and a pointing position in the second display screen 9b displayed at the display part 34 is detected. Finger coordinate information 4p is sent to the mobile terminal 1.

When receiving the finger coordinate information 4p, the mobile terminal 1 reports the finger coordinate information 4p as a selection event of the key or a button to the application 20.

In the second embodiment, it is difficult for the other persons 6 to read the private information. Hence, leakage of the private information is further suppressed.

In the display control of the private information in the first embodiment and the second embodiment, the operability of the user 5 is improved in addition to suppressing the leakage of the private information.

Hence, it is possible to conduct the display control related to the private information and for the user 5 to be sure of the operations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control method,, comprising:
receiving an image from a specific terminal; and
displaying, by a computer, the received image at a position of a display area of a display device, the position being corresponded to an image of the specific terminal in an image captured by an imaging device, when detecting at least one of the image of the specific terminal and an image corresponding to the specific terminal in the received image.

2. The display control method as claimed in claim 1, wherein the computer controls the display device to display the received image when the at least one of the specific terminal image and the representative image, which is captured by the imaging device, when an image of a marker being the representative image corresponding to the specific terminal is included in the received image captured by the imaging device.

3. The display control method as claimed in claim 2, wherein the image of the marker is displayed at the display device of the specific terminal.

4. The display control method as claimed in claim 2, wherein the controlling of the display device includes:
acquiring a location of the marker in the received image captured by the imaging device; and
displaying the received image at a location corresponding to an acquired location in the display area of the display device.

5. The display control method as claimed in claim 1, wherein the display device is a transmission type display device.

6. The display control method as claimed in claim 1, wherein the display device is a retina display device.

7. The display control method as claimed in claim 1, wherein the controlling of the display device includes filling at least one of multiple display components of a screen, which is to be displayed at the specific terminal, and displaying the multiple components at the specific terminal.

8. A non-transitory computer readable recording medium that stores a display control program that causes a computer to execute a process comprising:
receiving an image from a specific terminal; and
displaying the received image at a position of a display area of a display device, the position being corresponded to an image of the specific terminal in an image captured by an imaging device, when detecting at least one of the image of the specific terminal and an image corresponding to the specific terminal in the received image.

9. A wearable device, comprising:
a processor that executes a process to display an image received from a specific terminal at a display area of a display device, the process including
receiving an image from a specific terminal; and
displaying the received image at a position of a display area of a display device, the position being corresponded to an image of the specific terminal in an image captured by an imaging device, when detecting at least one of the image of the specific terminal and an image corresponding to the specific terminal in the received image.

10. An information processing terminal, comprising:
a processor that executes a process including
controlling displaying of a first image, in which a display component to display at a first display device of a terminal is filled with a single color and displaying of a second image of the display component by an original content at a second display device.

11. A wearable device, comprising:
conducting an image recognition process for
detecting at least one of a first image of a terminal and a second image corresponding to the terminal with respect to a third image captured by an imaging device; and
displaying a display image received by a communication device in a display area based on a result of the image recognition process.

12. A display control method, comprising:
displaying a display image, which a communication device receives, at a display area;
conducting an image recognition process to detect a finger image with respect to an image captured by an imaging device; and
sending, by the communication device, finger coordinate information indicating a position of a finger, which is acquired based on a result of the image recognition process.
